(19) United States
(12) Patent Application Publication
(10) Pub. No.: US 2004/0239511 A1
(43) Pub. Date: Dec. 2, 2004

(54) Fire hazard prevention system

(76) Inventors: Bezalel Urban, Van Nuys, CA (US); David Weisman, Peretz St. Kefar-Saba (IS)

Correspondence Address: KNOBBE MARTENS OLSON & BEAR LLP, 2040 MAIN STREET, FOURTEENTH FLOOR, IRVINE, CA, 92614, US

(21) Appl. No.: 10/492,511

(22) PCT Filed:
(86) PCT No.: PCT/IL02/00810

Related U.S. Application Data
(60) Provisional application No. 60/328,797, filed on Oct. 15, 2001.

(51) Int. Cl. G08B 17/00

(52) U.S. Cl. 340/584; 340/600

(57) ABSTRACT

This invention provides a new safety device for monitoring the cooking process of conventional range-top by adding a temperature measurement unit and algorithm to detect abnormal cooking scenarios. The safety device includes an active radiation signal generator, which emits radiation at a known frequency. The system differentiates between the passive signal and reflected signal of the total emitted radiation signal in order to calculate the accurate emissivity value of the target object The safety device is programmed to identify different heating scenarios by comparing the actual temperature/time curve of target object to temperature/time curves of known cooking scenarios. When a hazardous situation is identified, actions are taken to prevent fire.

### FIELD OF INVENTION

The present invention relates to measuring, monitoring and controlling devices for heating processes in general and more particularly for detecting the temperature of objects on stovetops to prevent hazardous situations and possible damage.

### BACKGROUND OF THE INVENTION

Gas and electrical range-tops (stovetops) are commonly used in commercial and domestic kitchens.

According to United States Government agencies, namely the Consumer Product Safety Commission and the National Fire Administration, stovetop and oven accidents are the leading cause of residential fires in the USA (February 1998). It is estimated that there were an average of 93,800 fires resulting in 250 deaths and 4,700 injuries. On average, someone calls the fire department for a fire in the kitchen every nine minutes.

Investigations indicate that a great number of accidents occur by the ignition of overheated objects. Thirty percent of all residential fires are caused by electrical or gas stoves when the user has forgotten to turn off the stove. Even in cases where such negligence does not result in fire, other economic damage, namely destruction of hot plates and/or cooking-vessels, occurs due to overheating. Injuries to persons and damage to property also occur with other types of objects, such as electrical appliances, machines and motors as a consequence of overheating.

Statistics obtained from fire departments show that kitchens are the most frequent areas of residential fire origin. All cooking appliances other than range-top burners are controlled by time and temperature. This exception has made the range-top burners a major fire hazard in residential kitchens where many fires begin due to negligence when a stove is accidentally left unguarded. The content of the utensil eventually ignites when the dried food is held at cooking temperatures for a prolonged period after all liquids have evaporated, or oil based food has reached the auto ignition temperature point.

U.S. Pat. No. 5,294,779 discloses a combination sensor installed in the center of an electric hotplate that senses the presence of a utensil, measures its temperature and cuts off electrical supply to the hotplate when temperature reaches a predetermined value.

U.S. Pat. No. 5,094,259 discloses an automatic shut-off safety device for a gas stove fitted between the gas intake pipe and the catch base.

U.S. Pat. No. 5,196,830 discloses an apparatus for supervising objects such as hot plates and electrical stoves, with regard to overheating. It is comprised of at least one detector for overheating conditions and a device controlled by the detector for sounding an alarm. This apparatus detects infrared radiation emitted from a heated object.

The above-described patents do not provide a solution for utensils that are made of reflective or transparent material such as metal or glass. Most patents describe methods that measure the target object temperature using infrared sensors. However, such measurements are not accurate and have a high degree of deviation, resulting in false alarms or failure to sound an alarm in response to a hazardous condition.

In addition, prior solutions ignore the differences between different types of cooking processes such as frying and boiling. As a result, the interpretations and analyses of situations that require system alarm activation are not necessarily correct.

The present invention suggests a new safety device for controlling range-top energy source with the highest standard of safety, durability and self-calibration, by means of detecting radiation emitted from a heated object and identifying abnormal situations.

### BRIEF SUMMARY OF THE INVENTION

The present invention provides a new method for measuring and monitoring the temperature of a target object, which is heated by an energy source. The method is applied by generating and transmitting a radiation signal at a certain frequency towards the target object, detecting the total emitted radiation from the target object, and differentiating between passive target emitted radiation signal and reflected radiation signal. The temperature of the target object is calculated as a function of the “passive” radiation signal and accurate emissivity value, wherein the corrected emissivity value is calculated as a function of the difference between the generated radiation and the reflected radiation.

The method further enables the identification of heating process characteristics by comparing the temperature-time curve of the actual process to estimated curves of known heating scenarios. The temperature-time curve of the actual process is calculated as a function of time according to measured samples of temperatures. Comparing the current temperature to pre-determined threshold values of the established heating scenarios recognizes hazardous situations. When threshold values are exceeded, action is then taken to prevent fire. When the first threshold is passed the system alerts the user by sounding an alarm, and when a second threshold is exceeded the system shuts off the energy source.

### BRIEF DESCRIPTION OF THE DRAWINGS

These and further features and advantages of the invention will become more clearly understood in light of the ensuing description of a preferred embodiment, given by way of example only, with reference to the accompanying drawings, wherein—

FIG. 1 is a general block diagram of the implemented safety system according to the present invention.

FIG. 2 is a functional block diagram of the implemented safety system according to the present invention.

FIG. 3 is a block diagram of the sensor according to the present invention.

FIG. 4 is a flow chart of a typical cooking process algorithm according to the present invention.

FIG. 5 is a typical temperature-time curve of a water-based liquid boiling response.

FIG. 6 is a typical temperature-time curve of oil-based frying response.

### DETAILED DESCRIPTION OF THE PREFERRED EMBODIMENTS

This invention provides a new safety device for monitoring the cooking process of conventional range-top heat source by adding a temperature measurement unit and algorithm to detect abnormal cooking scenarios. The safety device is programmed to identify dangerous situations, to alert the users thereof and to shut off the flow of electricity or gas when the temperature of the utensil exceeds a set of pre-defined threshold values.

This safety device includes an innovative sensitive temperature measurement device, which can be incorporated in new and existing range-tops and operate without interfering with the cooking process.

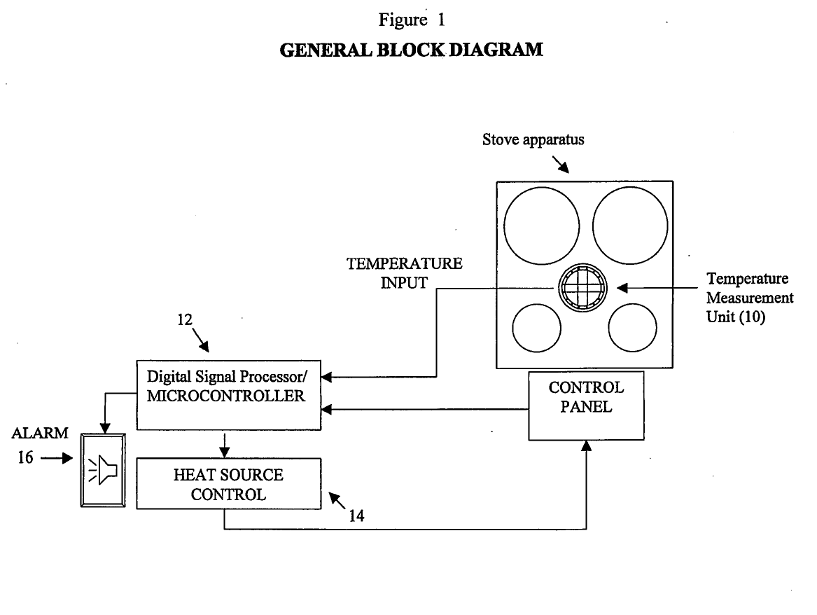

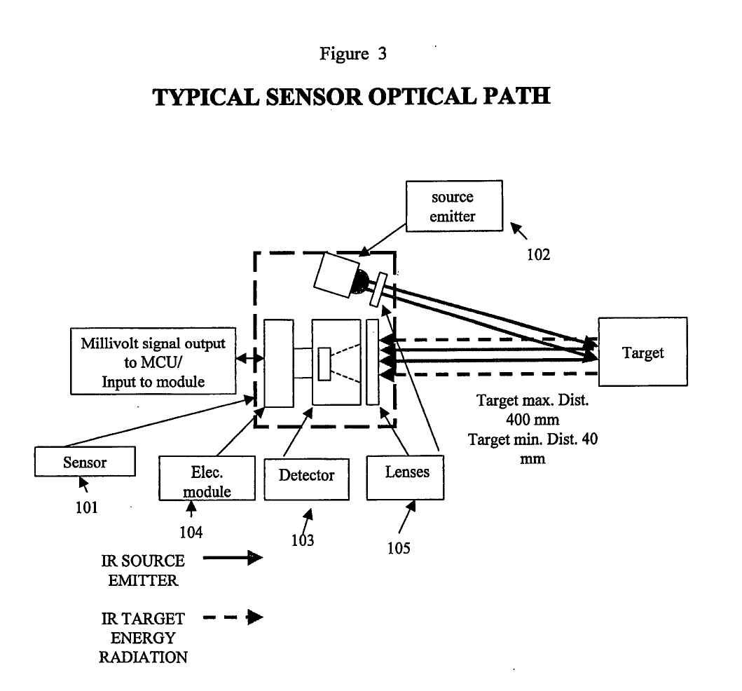

An illustration of the safety device components incorporated within a standard range-top can be seen in FIG. 1. The Temperature Measurement Unit (10), incorporating sensors such as shown in FIG. 3, may be positioned on the range-top in-between the heat sources such as gas burners or electrical heating elements. The output of the measurement unit is transferred to the micro-controller (12) for analyzing and processing. The micro-controller supervises the heat source control unit (14), which is programmed to decrease the energy flow or shut it off in case of emergency. The micro-controller activates an alarm device (16) as a first active step if the temperature exceeds the safety threshold. If corrective measures are not taken and the second safety threshold is reached, the system will terminate energy source.

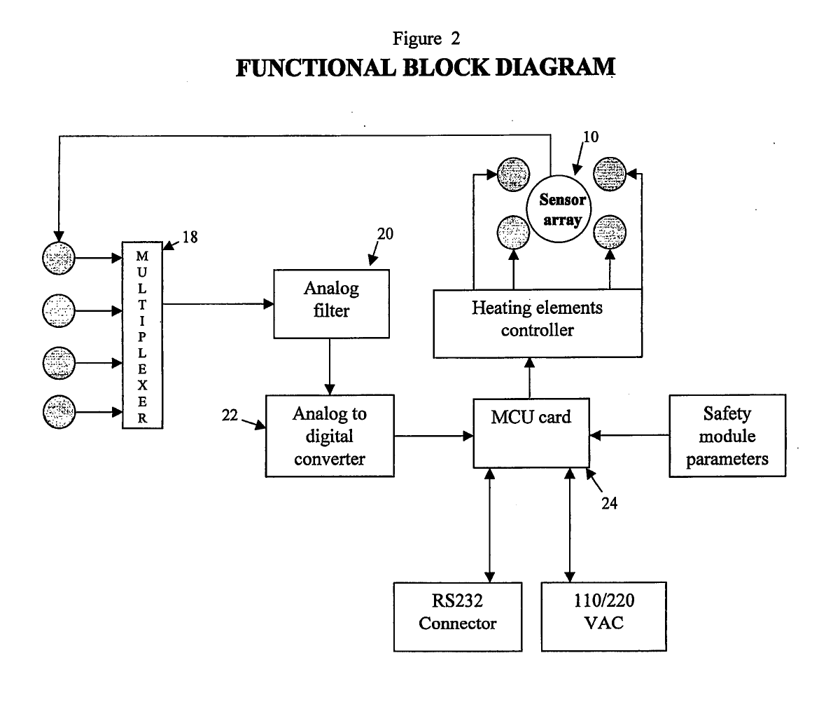

A more detailed block diagram of the safety system is illustrated in FIG. 2. The signals detected by the sensor are sent from the Temperature Measuring Unit (10) to a Multiplexer (18) for the purpose of creating a single analog output of the target object temperature. The analog signal is attenuated by an analog filter (20) and converted into digital data using an analog-to-digital converter (22).

The Microcontroller Unit (MCU) card (24) receives the digital input from the converter module and uses pre-defined safety parameters to determine if operative actions should be taken based on a cooking scenarios algorithm (as specified below).

The temperature measurement unit block diagram according to the preferred embodiment of the present invention is illustrated in FIG. 3. The unit is comprised of a passive radiation detector (103) and a radiation source emitter (102). The radiation sensor is comprised of a radiation detector (103) (such as an infrared detector) for converting the energy emitted from the target object into electrical signals, an electrical module (104) for processing detected signals and optical (Fresnel) lenses (105).

A conventional structure of a measuring unit comprises a passive radiation detector and optical lens, which acts as a passive unit for detecting the radiation emitted from the target object. In order to calculate the temperature measurement of a target object as a function of the measured radiation, the emissivity value of the target object needs to be determined.

Emissivity is a measure of the thermal emittance (emission power) of a surface. It is defined as the fraction of energy being emitted relative to that emitted by a thermally black surface (a black body). Each material type has a different emissivity value; in addition, the emissivity value is not the same for different surfaces of the same material or at different temperature levels. This is due to the fact that emissiviiy is a measure of the “surface” emittance of an object. The surface of objects (especially metals) changes over time. For example, oxidized copper has a significantly different emissivity value than shiny copper. Thus, it would not be accurate to use pre-calculated emissivity values of a specific material for calculating object temperature.

In practice, since most utensils used for cooking are made of metals such as aluminum, stainless steel, copper, steel etc., the calculation of accurate emissivity values is essential for the determination of the utensil temperature. The present invention suggests the use of an active radiation signal generator (for example, an infrared radiation source emitter), which emits radiation at a known frequency.

The Temperature Measurement Unit (10) detects the total radiation emitted form the target object. The total emitted radiation signal is differentiated to a passive target radiation signal, and a reflected radiation signal. The reflected radiation signal is used for calculating the accurate target emissivity value. It is known that a blackbody target object's reflective radiation is zero, since all energy is absorbed and no radiation is reflected. It is also a known fact that in a perfect mirror all radiation is reflected, and thus the reflective radiation is equal to the generated radiation. The emissivity value of the target object can therefore be deduced from the difference between the known (generated) radiation and the reflected radiation.

Once the emissivity value is known, the target temperature can be ascertained as a function of the passive radiation measurement and the target object's calculated emissivity value.

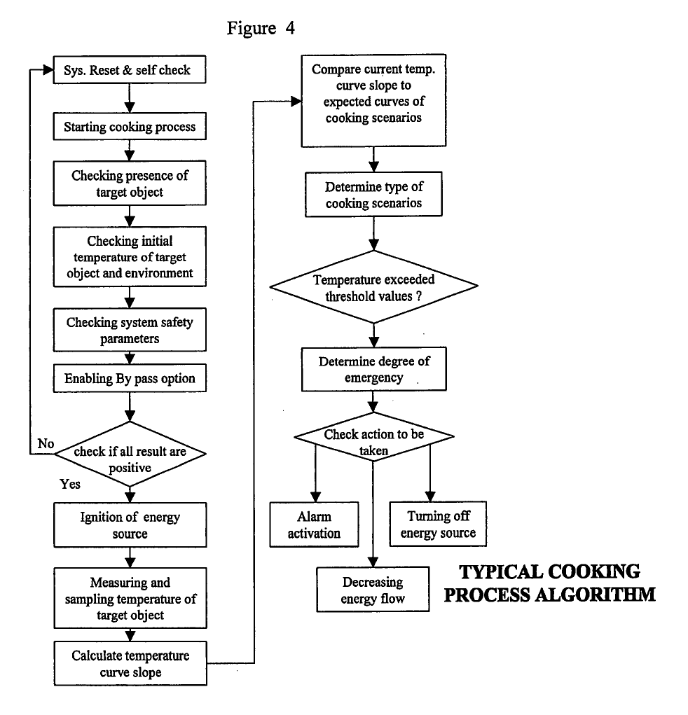

FIG. 4 illustrates the cooking scenario algorithm flow chart used by the MCU card for identifying hazardous situations. This algorithm reflects the characteristics of general cooking scenarios of water based and oil-fat based as outlined in the following paragraphs.

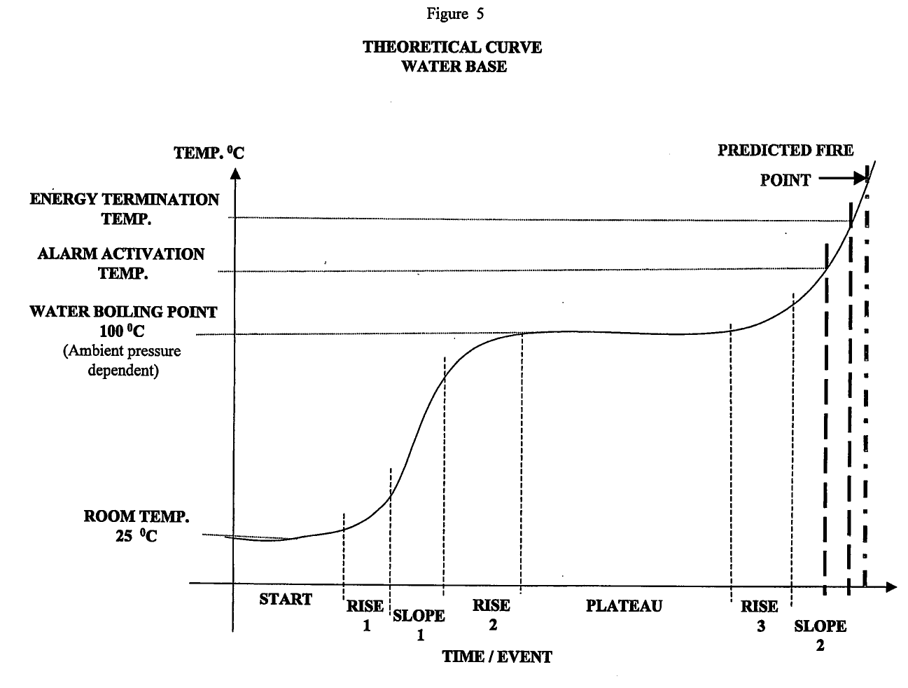

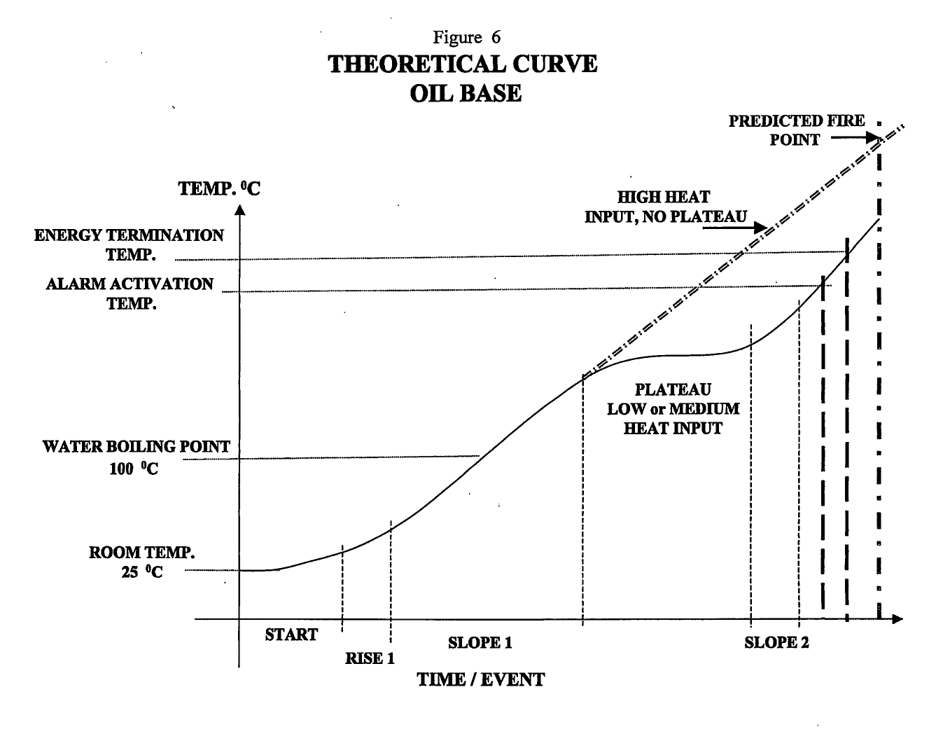

The oil-fat based process is characterized by high cooking temperatures and a relatively shorter duration. The typical estimated temperature graph during a frying process is illustrated in FIG. 5. The increased temperature reflected in this curve will maintain its slope as long as the energy source is maintained at a constant uninterrupted temperature level. The cooking utensil's temperature during the frying process may be maintained well above the boiling temperature of water-based liquid of 212 degrees Fahrenheit (100 degrees Celsius, at sea level). The water-based boiling or steaming process is characterized by maximum potential temperature and long duration. Its temperature graph, as seen in FIG. 6, illustrates a curve sloping upwards, with a flat segment during the water-evaporating period that starts at the boiling point.

When a utensil contains water-based liquid, the temperatures of the utensil will rise initially until the boiling point and then be held fairly constant at or below the boiling point of water. The temperature is unchanged due to the fact that the added heat is mostly being absorbed by the liquid and utilized in the vaporization process. Therefore, as long as there is liquid in the utensil, the temperature in the utensil will stay at or below the boiling point of the liquid. As mentioned above, these characteristics of the cooking process are implemented in the cooking algorithm for detecting abnormal situations.

As seen in FIG. 4., the safety system initiates its supervision when a user starts the cooking process. First the safety system resets and performs a self-checkup of the initial conditions of the range-top surface, presence of the target object, the surrounding environment, and in particular, the initial target temperature.

Following this safety check, the safety system verifies that the initial environmental conditions are in line with the safety parameters that are defined within the system. Some of these parameters may be controlled by the user to enable greater flexibility of the cooking process. Once the checkup process is completed, the system automatically enables the ignition of the energy source. During the cooking process the safety system measures the target object temperature and samples the temperature as a function of time. Based on these samples, the system calculates the temperature\time curve. This curve is compared to the estimated temperature\time curve of different cooking scenarios. The most typical scenarios are boiling and frying scenarios (their estimated temp.\time curves are illustrated in FIGS. 5 and 6). Thereafter, the safety system identifies the current cooking scenario and once identified, the system compares the measured temperature and slope angle to the estimated threshold values as were defined for each cooking scenario. The desired operative action is defined for each threshold. For example, as the temperature reaches the first threshold value, the safety system decreases the energy flow. If the temperature keeps rising beyond a second threshold value, an alarm is activated. If the temperature reaches a third threshold value, the safety system shuts off the energy source.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

1: A method for measuring and monitoring temperature of a target object which is heated by an energy source, comprising:
generating and transmitting a source radiation signal at a known frequency toward the target object;
detecting a total emitted radiation signal from the target object; and
differentiating between a passive emitted radiation signal and a reflected radiation signal;
calculating an emissivity value for the target object based on the difference between the source radiation signal and the reflected radiation signal; and
calculating the temperature of the target object as a function of the passive emitted radiation signal and the emissivity value of the target object.

2: The method of claim 1 wherein the source radiation signal is infrared.

3: The method of claim 1 wherein the source radiation signal is within visible light wavelength.

4: The method of claim 1 wherein heating process characteristics are identified by comparing the an actual process temperature-time curve, calculated according to measured samples of temperatures as a function of time, to an estimated curves curve of at least one known heating scenarios scenario.

5: The method of claim 4 wherein hazardous situations are identified by comparing the temperature of the target object to at least one pre-determined threshold value of the known heating scenario.

6: The method of claim 5 further comprising the step of determining a reaction to be taken if the temperature of the target object exceeds the pre-determined threshold value.

7: The method of claim 4 wherein the target objects are object is a utensil and the known heating scenario represents a cooking scenario.

8: The method of claim 6 wherein the threshold value represents at least one alert situation and the reaction represents at least one control action for preventing hazardous events.

9: The method of claim 6 wherein a plurality of pre-determined threshold values are provided which represent different degrees of alert and a plurality of respective reactions are selected to respond to the different degrees of alert.

10: The method of claim 7 wherein the cooking scenario is a water-based process which is characterized by maintaining a constant temperature during the evaporation process.

11: The method of claim 7 wherein the cooking scenario is a oil-based (fat based) process characterized by a curve that slopes upwards as long as the energy source is on and sustains constant uninterrupted temperature level.

12: A system for measuring and monitoring temperature of objects which are heated by an energy source, said system comprising:
a radiation sensor for measuring an emitted radiation signal from a target object;
a radiation source emitter for generating and transmitting a source radiation signal at a known frequency toward the target object; and
a computing means; for differentiating the emitted radiation signal into a passive radiation signal and a reflective radiation signal and wherein the target object temperature is calculated as a function of the passive radiation signal and an emissivity value of the target object, wherein the emissivity value is calculated as a function of the difference between the source radiation signal and the reflective radiation signal.

13: The system of claim 12 wherein the source radiation signal is infrared.

14: The system of claim 12 wherein the source radiation signal is within visible light wavelength.

15: The system of claim 12 further comprising:
a temperatures-time sampling means; and
data records of pre-calculated estimated curves and threshold values of different heating scenarios, wherein hazard alert events are determined by identifying a particular heating scenario of the target object according to a comparison between a curve which is calculated according to temperature samples to estimated curves of different heating scenarios and comparing the temperature of the target object to a predetermined threshold value of the identified heating scenario.

16: The system of claim 15 further comprising a control means for preventing hazardous events by a programmed action to be carried out in the event that the temperature of the target object exceeds the pre-determined threshold value.

17: The system of claim 16 wherein the target object is a utensil and the identified heating scenario represents a cooking scenario.

18: The system of claim 17 wherein the pre-determined threshold value represents at least one alert situation and the programmed action represents at least one control action for preventing hazardous events.

19: The system of claim 18 wherein a plurality of pre-determined threshold values are provided which represent different degrees of alert and a plurality of respective reactions are selected to respond to the different degrees of alert.

20: The system of claim 19 wherein the cooking scenario is a water-based process characterized by having a constant temperature during the evaporation process.

21: The system of claim 19 wherein the cooking scenario is an oil-based process characterized by a curve that slopes upwards as long as the energy source is on and sustains a constant uninterrupted temperature level.
